(19) United States
(12) Patent Application Publication
(10) Pub. No.: US 2005/0158510 A1
(43) Pub. Date: Jul. 21, 2005

(54) Display table cover

(76) Inventor: Lorie L. Trump, Billings, MT (US)

Correspondence Address: Lorie Trump, 8430 Angus Avenue, Billings, MT, 59105, US

(21) Appl. No.: 10/758,551

(22) Filed: Jan. 15, 2004

(51) Int. Cl. B32B 3/06

(52) U.S. Cl. 428/102

(57) ABSTRACT

A table cover that allows the user to display literature or product samples in pockets that extend vertically from the edge of the table, comprising a water-resistant and lightweight primary material and a transparent secondary material from which the pockets are made. The pockets can be made either from a single sheet of transparent material or from a plurality of sections of transparent material. The pockets can vary in number and size, and they can be located in one or two rows on one or both sides of the table. In the preferred embodiment, the primary material is nylon ripstop coated with urethane, and the secondary material is clear window plastic. The secondary material can be UV-treated to prevent fading of the literature or other materials contained in the pockets, and text and/or graphics can be superimposed on the front surface of the pockets.

### CROSS-REFERENCE TO RELATED APPLICATION

This application is an original nonprovisional application. It does not claim priority back to any previously filed patent application.

### BACKGROUND OF THE INVENTION

1. Field of the Invention

The present invention relates to the field of table covers, and more particularly, a tablecloth used for display purposes at trade shows and the like.

2. Description of the Related Art

A number of flat items, some of which are foldable, have been designed to provide display means for particular purposes, but none relates to a table cover that can be used for exhibition purposes. At trade shows and similar functions, vendors typically place their literature and product samples on top of the table, which leaves little room for anything else (such as a writing or eating surface). The problem that exists, and that is solved by the present invention, is the lack of a means for organizing literature and product samples neatly at trade shows while maximizing the amount of table space available. The applicant is not aware of any product on the market today that provides a table cover with the unique functionality of the present invention. Some examples of flat and/or foldable display items are provided below.

U.S. Pat. No. 4,944,968 (Wagner, 1990) discloses a placement with a changeable card display. The placement has a panel with an array of clear plastic film pockets. The pockets are sized to accommodate baseball or other sports cards. The placement is imprinted with text or graphics relating to the team of the athletes whose cards are placed in the pockets. The pockets can be individually secured to the placement or made of a single sheet that is laid over the entire placement.

U.S. Pat. No. 6,113,454 (Mitchell, 2000) relates to an amusement center for rear-facing infant child seats. The amusement center consists of a soft flexible display structure that consists of a plurality of panels, each of which has a toy or similar entertainment item attached to it. The display structure is supported by clips or straps that hang over the back of a vehicle seat, and it can be further supported by VELCRO® attachments to the vehicle seat. The entertainment items that can be attached to the display structure include photos or pictures, soft dolls or animals, and music boxes.

U.S. Pat. No. 4,988,556 (Nilsen et al., 1991) describes a device for mounting transparencies. The device consists of front and back transparent plastic sheets that are bonded together to form a plurality of pockets into which the transparencies can be inserted. In a preferred embodiment, the device is used to store dental X-ray film, and the film can be viewed through an overhead projector without distortion while in the pockets of the display device.

U.S. Pat. No. 6,336,555 (Breeden, 2002) provides an organizer for school supplies that attaches to the outside of a desk and can be removed and carried to another location. The organizer includes a main back portion that is formed of a single piece of fabric and that is folded in half and sewn to form a top compartment for magnets, a main compartment for markers and paper, and a bottom compartment for pencils and similar objects. The organizer also includes a front pocket portion that is formed of a single piece of cloth and that is sewn onto the front of the main portion.

U.S. Pat. No. 5,984,092 (Heard-Willmon 1999) involves a folding organizer that consists of a single flexible sheet divided into six or more panels by parallel folds. Each panel has an inner face onto which pockets, loops or other display means can be attached. The organizer can be collapsed into a compact position and held in a closed position by fasteners. The patent also discloses certain specialized cases that can be used to carry the organizer.

U.S. Pat. No. 6,453,592 (Pliler et al., 2002) describes a holder for displaying coins and souvenirs that is comprised of substantially rigid front and back panels secured together to fold or hinge about a common side defining an axis. The holder further comprises a plurality of planar mounting positions created by a transparent retaining cover-that is attached to the mounting face of the inside surface of the front and back panels. The mounting positions are vertically spaced rectangular surfaces that are arranged in lateral pairs on the mounting face. The coins or souvenirs are inserted in between the mounting face and the transparent retaining sheet.

U.S. patent application Pub. No. 2003/0089749 (Valdez-Campell, 2003) presents a flexible, foldable multi-article storage carrier that comprises a sheet of flexible material with a plurality of compartments on one side for containing the articles to be stored. The carrier can be used as a mat or blanket when unfolded and as a carrier when folded or rolled. The carrier was intended to be used by small children to transport dolls, small stuffed animals, and the like.

Despite more than a decade of patented designs for various types of flat or folded storage and/or display devices, no one has patented a table cover that provides a means of organizing literature and product samples at trade shows and similar venues. It is an object of the present invention to provide a table cover that solves this problem. It is a further object of the present invention to use materials that are water-resistant, durable and aesthetically pleasing. Another object of the present invention is to provide a display table cover that can be personalized to reflect the name and/or logo of the user.

### BRIEF SUMMARY OF THE INVENTION

The present invention relates to a table cover comprising a sheet of primary material that fits over the surface of a table and extends vertically downward in front and back of the table to create a front and back vertical face of the table cover, a secondary material from which pockets are constructed on the front and/or back vertical face of the table cover, and a means of attaching the primary material to the secondary material, wherein the primary material is both water-resistant and lightweight, and the secondary material is transparent. In the preferred embodiment, the primary material is nylon ripstop coated with urethane.

In one embodiment, the secondary material is a single piece of clear window plastic that is attached to the primary material by stitching that extends horizontally along the bottom of the clear plastic and vertically from the bottom edge to the top edge of the clear plastic on either side of the clear plastic, and wherein the pockets are formed by stitching that extends vertically from the bottom of the clear plastic to the top of the clear plastic at intervals that define the size of the pockets. In another embodiment, the secondary material comprises two pieces of clear window plastic arranged so as to provide two parallel rows of pockets, and wherein each piece of clear plastic is attached to the primary material by stitching that extends horizontally along the bottom of each piece of clear plastic and vertically from the bottom edge to the top edge of the clear plastic on either side of each piece of clear plastic, and wherein the pockets are formed by stitching that extends vertically from the bottom of each piece of clear plastic to the top of each piece of clear plastic at intervals that define the size of the pockets.

In a third embodiment, the secondary material comprises a plurality of pieces of clear window plastic that are attached to the primary material by stitching that extends horizontally along the bottom of each piece of clear plastic and vertically from the bottom edge to the top edge of each piece of clear plastic on either side of each piece of clear plastic, and wherein the pockets are arranged in one or two horizontal rows.

Optionally, the clear window plastic can be UV-treated, and the front surface of the pockets can include text or graphics. In the preferred embodiment, the pockets comprise a plurality of larger pockets and smaller pockets; the larger pockets are at least ten inches wide, the smaller pockets are at least six inches wide, and the pockets are at least eight inches high. In an alternate embodiment, the pockets are uniform in size.

### BRIEF DESCRIPTION OF THE DRAWINGS

FIG. 1 is a perspective view of the preferred embodiment of the present invention in use on top of a table.

FIG. 2 is a plan view of a first embodiment of the present invention.

FIG. 3 is a plan view of a second embodiment of the present invention.

### REFERENCE NUMBERS

1. Primary material
2. Secondary material
3. Stitching
4. Larger pocket
5. Smaller pocket

### DETAILED DESCRIPTION OF INVENTION

The present invention is a table cover that allows the user to display literature or product samples in pockets that extend vertically from the edge of the table while leaving the top of the table free for other purposes. The table cover of the present invention comprises a primary material that is water-resistant and lightweight and that will fold over the edges of the table and a secondary material that is transparent from which the pockets are made. The primary material can be of any color, but it must be both water-resistant and lightweight in order to prevent spills from ruining the tablecloth and to facilitate transport and installation of the tablecloth. The pockets can be made either from a single sheet of transparent material or from a plurality of sections of transparent material. The pockets can vary in number and size, and they can be located in one or two rows on one or both sides of the table.

In the preferred embodiment, the primary material is nylon ripstop coated with urethane, and the secondary material from which the pockets are made is clear window plastic. The secondary material is stitched to the primary material to form the pockets. Optionally, the secondary material can be UV-treated to prevent fading of the literature or other materials contained in the pockets.

Advantages of the table cover of the present invention are that its design allows the user to clean up a spill or other mess on top of the table without dismantling the entire display. The table cover can hold numerous items at a time and is easily restocked. It can also be folded with brochures still in it, and it is easy to assemble and store.

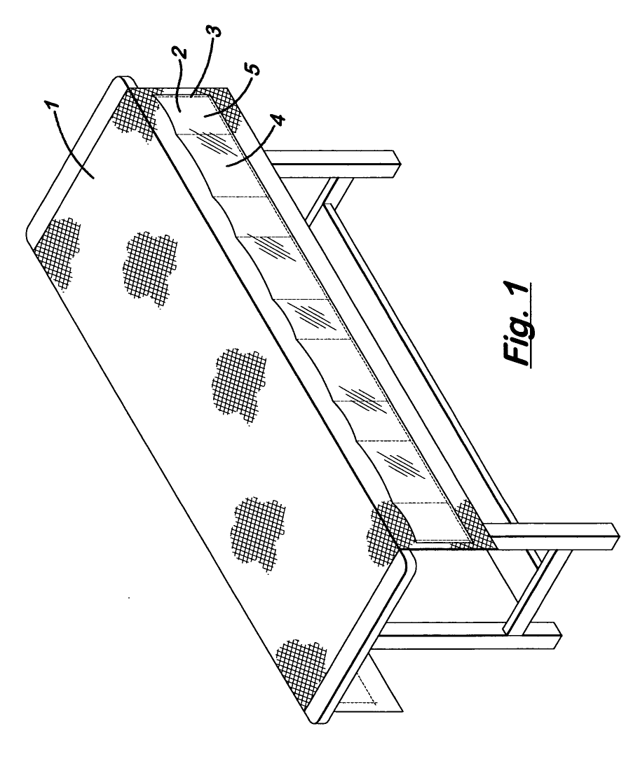

FIG. 1 is a perspective view of the preferred embodiment of the present invention in use on top of a table. The primary material 1 is placed over the table, and the sides are allowed to hang over the front and back of the table. A secondary material 2 is attached to the primary material to form a horizontal row of pockets on the front and/or back side of the table. In the preferred embodiment, there are four larger pockets 4 and four smaller pockets 5 in each row, with alternating larger pockets 4 and smaller pockets 5. An option, not shown in this figure, is to customize the table cover to reflect a company's name and/or logo by superimposing text or graphics on the front surface of the pockets.

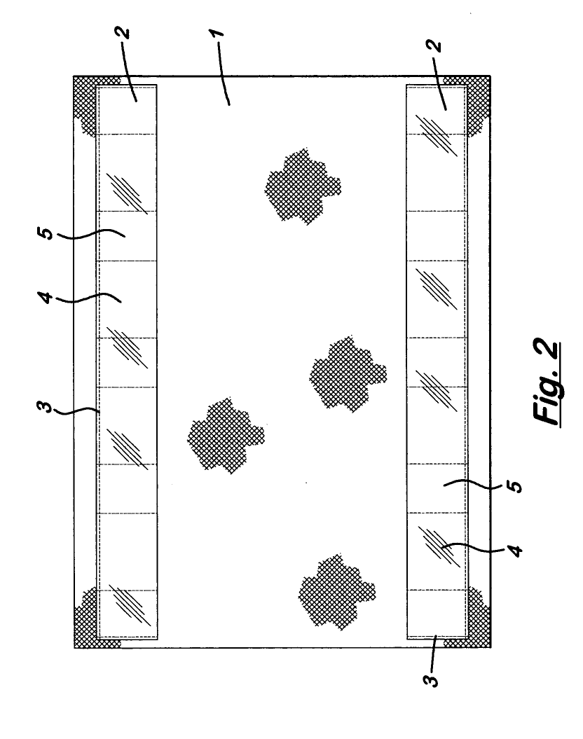

FIG. 2 is a plan view of a first embodiment of the present invention. In this embodiment, the secondary material 2 is a single piece of clear plastic material that is sewn to the primary material 1. The stitching 6 runs vertically on either side of the secondary material 2 and horizontally across the bottom of the secondary material 2. The pockets are formed by stitching 6 that extends vertically from the bottom edge to the top edge of the secondary material 2. The pockets can be of any size and number, as long as they fit within the size of the piece of secondary material.

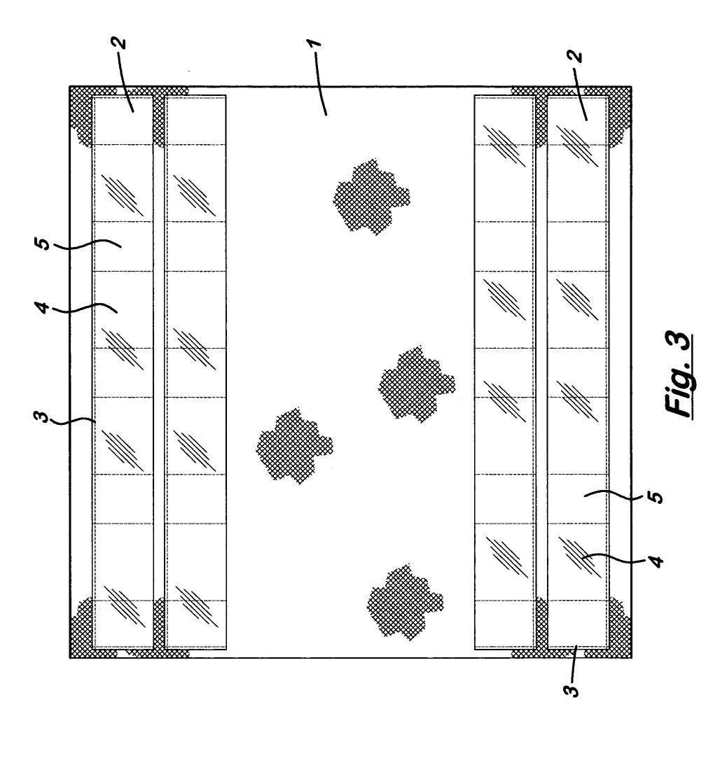

FIG. 3 is a plan view of a second embodiment of the present invention. In this embodiment, there are two rows of pockets, one on top of the other, on the front and/or back of the table cover. The pockets are formed by two pieces of secondary material 2, each of which is attached to the primary material 1 in the same manner as in FIG. 1. Similarly, the larger pockets 4 and smaller pockets 5 are formed by vertical stitching of the secondary material 2 to the primary material 1, as described in reference to FIG. 2.

The pockets could be of one uniform size rather than two different sizes, as shown in FIG. 1 through 3, and they could also be made out of several smaller sections of secondary material rather than one piece of secondary material per row, as shown in FIGS. 1 through 3. The preferred embodiment includes only one piece of secondary material per row because this embodiment facilitates the manufacturing process and maximizes the amount of pocket space available. The preferred embodiment also includes two different pocket sizes because the larger pockets 4 accommodate standard 8½ by 11-inch materials, and the smaller pockets will keep narrower brochures upright. In the preferred embodiment, the larger pockets 4 are approximately 10¼ inches wide, the smaller pockets 5 are approximately 6¾ inches wide, and the pockets are approximately 8¼ inches high.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1. A table cover comprising a sheet of primary material that fits over the surface of a table and extends vertically downward in front and back of the table to create a front and back vertical face of the table cover, a secondary material from which pockets are constructed on the front vertical face of the table cover, and a means of attaching the primary material to the secondary material, wherein the primary material is both water-resistant and lightweight, and the secondary material is transparent.

2. A table cover comprising a sheet of primary material that fits over the surface of a table and extends vertically downward in front and back of the table to create a front and back vertical face of the table cover, a secondary material from which pockets are constructed on the back vertical face of the table cover, and a means of attaching the primary material to the secondary material, wherein the primary material is both water-resistant and lightweight, and the secondary material is transparent.

3. The table cover of claim 1 or 2, wherein the primary material is nylon ripstop coated with urethane.

4. The table cover of claim 1 or 2, wherein the primary material is nylon ripstop coated with a durable water repellent.

5. The table cover of claim 1 or 2, wherein the secondary material is a single piece of clear window plastic that is attached to the primary material by stitching that extends horizontally along the bottom of the clear plastic and vertically from the bottom edge to the top edge of the clear plastic on either side of the clear plastic, and wherein the pockets are formed by stitching that extends vertically from the bottom of the clear plastic to the top of the clear plastic at intervals that define the size of the pockets.

6. The table cover of claim 5, wherein the clear window plastic is UV-treated.

7. The table cover of claim 1 or 2, wherein the secondary material comprises two pieces of clear window plastic arranged so as to provide two parallel rows of pockets, and wherein each piece of clear plastic is attached to the primary material by stitching that extends horizontally along the bottom of each piece of clear plastic and vertically from the bottom edge to the top edge of the clear plastic on either side of each piece of clear plastic, and wherein the pockets are formed by stitching that extends vertically from the bottom of each piece of clear plastic to the top of each piece of clear plastic at intervals that define the size of the pockets.

8. The table cover of claim 7, wherein the clear window plastic is UV-treated.

9. The table cover of claim 1 or 2, further comprising a means of superimposing text or graphics on the front surface of the pockets.

10. The table cover of claim 1 or 2, further comprising vinyl cut-outs in the form of text or graphics that are placed on the front surface of the pockets with an adhesive.

11. The table cover of claim 1 or 2, wherein the pockets comprise a plurality of larger pockets and smaller pockets.

12. The table cover of claim 11, wherein the larger pockets are at least ten inches wide, the smaller pockets are at least six inches wide, and the pockets are at least eight inches high.

13. The table cover of claim 1 or 2, wherein the pockets are uniform in size.

14. The table cover of claim 1 or 2, wherein the secondary material comprises a plurality of pieces of clear window plastic that are attached to the primary material by stitching that extends horizontally along the bottom of each piece of clear plastic and vertically from the bottom edge to the top edge of each piece of clear plastic on either side of each piece of clear plastic, and wherein the pockets are arranged in one horizontal row.

15. The table cover of claim 1 or 2, wherein the secondary material comprises a plurality of pieces of clear window plastic that are attached to the primary material by stitching that extends horizontally along the bottom of each piece of clear plastic and vertically from the bottom edge to the top edge of each piece of clear plastic on either side of each piece of clear plastic, and wherein the pockets are arranged in two horizontal rows.
